(19) United States
(12) Patent Application Publication
(10) Pub. No.: US 2003/0131641 A1
(43) Pub. Date: Jul. 17, 2003

(54) Method for producing a humin-mineral concentrate and device for carrying out said method

(76) Inventor: Alexandr Ivanovich Shulgin, Moscow (RU)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/258,341

(22) PCT Filed: Feb. 22, 2001
(86) PCT No.: PCT/RU01/00077

(30) Foreign Application Priority Data
Apr. 24, 2000 (RU) 2000110073

(51) Int. Cl. C05F 11/02

(52) U.S. Cl. 71/24

(57) ABSTRACT

The humic-mineral concentrate is prepared from an aqueous suspension comprising humic acid salts and finely divided humic-mineral particles and complexes the content of which ranges from 1.5 to 20 wt. % of a total weight of the salts. Electrolysis of the salts and electrophoresis of the particles and complexes are carried out in two baths in the course of which processes humic acids and humic-mineral substances making up the concentrate are isolated on the anodes. The direction of electrolyte flow in each bath is opposite to the sense of anode rotation. Interposed between the baths is a collector communicating therewith via overflow holes for feeding the aqueous suspension. Each of the bath is provided a discharge container positioned under the end product extractor.

### TECHNICAL FIELD

The present invention relates to production of organo-inorganic fertilizers, ameliorants, soil conditioners, organo-inorganic preparations, sorbents, flocculents, coagulants, as well as organo-inorganic substances having surfactant, ion-exchange, astringent, and biologically active properties.

The invention will find application in farming practice for restoring properties and fertility of soils and increasing yielding capacity of farm crops; in public service for sewage treating and sediment salvaging, for restoring natural soil continuum, restoring properties of urban lands and their reclaiming, detoxifying and salvaging domestic and industrial waste products; in engineering ecology for recultivating disturbed, contaminated, and degraded lands and territories, salvaging liquid and solid waste, as well as in activities of environmental protection and restoration agencies.

It is the carbon-series caustobiolites (oil shales, fossil coals, peat), the naturally occurring humites (soil, fluvial, lacustrine, and marine clastic deposits), and the products of processing organic materials (composts) that serve as a source of the humic-mineral concentrate.

Background Art Known in the present state of the art is a process for humic concentrate production (cf. RF U.S. Pat. No. 2,125,039, IPC C 07 C 63/33, published on Jan. 20, 1999 in Bulletin of Inventions #2) by virtue of hydrolysis of a liquid-phase alkaline medium of humic acid salts extracted by an alkaline reagent from naturally occurring carbon-series caustobiolites to form the end product and withdraw it from the electrolyte. Used as said liquid-phase alkaline medium of humic acid salts is an aqueous solutions thereof. The electrolysis process is carried out in a single zone confined between the anode and cathode provided that an electric potential is established on the anode, high enough for anions of humic acids to discharge bot lower than the discharge potential of hydroxyl ions. The target humic concentrate is formed on the anode surface, comprising hydrated humic acids, salts of humic acids, and mineral components of the original humites and carbon-series caustobiolites, all of them being chemically bound with the humic acids contained in the humic concentrate.

The known process suffers from the following disadvantages:

electrolysis of an aqueous solution of the salts of humic acids involves thorough purification of the solution prepared by extracting humic acids by an alkaline reagent from the naturally occurring humites and carbon-series caustobiolites so as to get said solution rid of mineral, carbon, and organo-inorganic particles of the original raw stock, which is attainable due to a prolong settling (from a few hours to several days), followed by filtration or centrifugation. All this affects very badly the productivity of the process, complicates it, and adds to the cost of the end product;

electrolysis of a solution of the salts of humic acids in a single zone confined between the anode and cathode without a correct running of electrolyte with respect to anode results in that when humic concentrate is isolated on the anode, the pH value in the nearest electrolyte zones badly increases, whereby the isolated acids starts redissolving so that but a low proportion of said acid is extracted from the solution, i.e., there is an unpractical electric energy consumption and but a low current efficiency with respect to the yield of the end product;

it is due to a dynamic equilibrium arising between the process of acid isolation on the anode and of its dissolving in a strong alkaline medium that to set an electric potential on the anode sufficient for the anions of humic acid to discharge is not possible. Thus, said electric potential should be set at a higher level, with the result that a vigorous water electrolysis in electrolyte occurs, accompanied with hydrogen isolation on the cathode and oxygen, on the anode. All this increases waste of electric power and renders the process for producing humic acids fire-and-explosion hazardous;

use of graphite anode results in its rapid destruction due to its being oxidized with the liberated oxygen which affects adversely the efficiency and productivity of the process. Moreover, anode destruction contaminates both the solution and the end product with graphite particles;

use of anode having a surface coating from a costly ruthenium dioxide results in its rapid (for a few tens of hours) destruction with the scraper due to a high friction force effective in the zone of anode-to-cathode contact.

All the disadvantages mentioned before render the known process but low efficient, unproductive, power-consuming, and not very applicable for industrial use.

Known in the present state of the art is a device for humic concentrate production (see ibid.), comprising an electrolysis bath serving as a cathode, and an anode situated in the bath and provided with an end product extractor. The electrolysis bath appears as a horizontal cylindrical trough having end walls, and the anode appears as a drum arranged coaxially and at a clearance with said trough and rotatably about its longitudinal axis.

The known device suffers from the following disadvantages:

the device fails to provide a rational feed of electrolyte, its interacting with the anode and withdrawing spent solution, with the result that two contrary processes are running, i.e., isolating and dissolving humic acids, which necessitates increasing the electric potential. All this results in low productivity of the device, low efficiency and high power consumption of the process;

different anode surface areas are working under different conditions, especially when electrolyte moves along the side anode surface which affects adversely the operating efficiency and productivity of the device;

when hydrogen and oxygen bubbles are released from the humic acid salt solution throughout the electrolyte volume, its electric conductance is badly reduced which involves applying higher voltage and hence nonrational electric power utilization and setting up personnel safety hazard;

it is due to hydrogen and oxygen bubbling from the humic acid salt solution that a great deal of froth is liable to arise on the electrolyte surface. The froth flows over the bath walls and gets to the current lead, electric drive motor, and the floor, with the result that the current lead gets worn out and out of order rather rapidly, the resistance of the electric drive motor insulation is reduced, and the drive failure occurs rather frequently. Moreover, froth presents permanent danger of fire or explosion.

All the abovementioned disadvantages in combination render the known process but low efficient, unproductive, power-consuming, and not very applicable for practical use.

### SUMMARY OF THE INVENTION

It is an object of the present invention to provide a process for producing a humic-mineral concentrate and a device for carrying said process into effect, said process involving the use of such electrolyte and operating under such conditions and said device having such a construction arrangement that enable one to increase efficiency and productivity of the process, to reduce power consumption thereof, to dispense with a necessity for fine electrolyte cleaning from mineral, hydrocarbon, and organo-inorganic particles of the original raw stock for producing a solution of the salts of humic acids, and to provide convenient operation and attendance of the device and its fire- and explosion safety.

The foregoing object is accomplished due to the fact that in a process for producing a humic-mineral concentrate by resorting to electrolysis of a liquid-phase alkaline medium of humic acid salts extracted with an alkaline reagent from naturally occurring carbon-series humites and caustobiolites to form humic acids on the anode surface, followed by extracting the end product from electrolyte, according to the invention, used as the liquid-phase alkaline medium is an aqueous suspension of humic acid salts obtained by alkaline extraction of caustobiolites, and comprising humic acid salts and finely divided humic-mineral particles and complexes whose content is equal to 1.5-20 wt. % of a total weight of humic acid salts. Electrolysis of an aqueous suspension of humic acid salts involves electrophoresis of finely divided humic-mineral particles and complexes to form humic-mineral substances on the anode surface, which substances form, together with humic acids isolated during electrolysis, the end product; a stream of said aqueous suspension is uniformly distributed over the anode working surface and runs in a direction opposite to that of anode rotation, and damping zones are provided in the anode space for suppressing froth forming when electric current is passed through the aqueous suspension.

It is expedient to use an anode having the working surface made of magnetite and to remove the suspension film from the surface of the end product when the latter is withdrawn.

The foregoing object is also accomplished due to the fact that the device for producing humic-mineral concentrate comprising an electrolysis bath serving as a cathode, and an anode situated in the bath and provided with an end product extractor, both said cathode and said anode being connected to a direct-current source, according to the invention, comprises at least one additional bath and anode so as to establish at least a pair of baths between which a distributing collector is positioned, communicating with the baths through overflow holes for feeding to the baths an original aqueous suspension of humic acid salts, each of said baths being provided with a discharge container located under the end product extractor and each of the anodes has a froth-suppressing attachment and is rotatable in a direction opposite to that of motion of the original aqueous suspension in the bath.

The distributing collector may appear as a cylindrical trough and the extensions, as vanes positioned in the end zones of the anode spaces, said zones facing to each other, while each of the overflow holes may appear as a slit.

The device may further comprise a remover of the suspension film from the surface of the end product, said remover appearing either as a slotted tube so positioned as to provide feeding a compressed air stream (from a source thereof) towards the anode and opposite to the sense of its rotation, or as a frame carrying a web of cloth stretched thereover so as to be forced against the anode surface.

### BRIEF DESCRIPTION OF THE DRAWINGS

In what follows the alleged invention will now be illustrated by specific embodiments thereof with reference to the accompanying drawings, wherein:

FIG. 1 is a schematic view of a device for producing humic-mineral concentrate provided with a pair of electrolysis baths;

FIG. 2 is a schematic view of a device for producing humic-mineral concentrate provided with two pairs of electrolysis baths;

FIG. 3 is a section taken along line 3-3 in FIG. 2;

FIG. 4 is a view facing arrow A in FIG. 2;

FIG. 5 is a view facing arrow B in FIG. 2;

FIG. 6 is a view facing arrow C in FIG. 2;

FIG. 7 is a view of a remover of a suspension film from the surface of the end product, appearing as a frame carrying a web of cloth stretched thereover.

FIG. 8 is a section taken along line 8-8 in FIG. 7.

### DETAILED DESCRIPTION OF THE INVENTION

According to the proposed invention the humic-mineral concentrate is reasonable to be produced from an original aqueous suspension of humic acid salts, which is obtained by virtue of alkaline extraction of naturally occurring carbon-series humites and caustobiolites and which comprises predominantly salts of humic acids and finely divided humic-mineral particles and complexes. The proposed invention provides for running concurrently proceeding processes of electrolysis of humic acid salts to form humic acids on the anode surface, and of electrophoresis of finely divided humic-mineral particles and complexes to form humic-mineral substances on the surface of said anode which substances form, together with humic acids, the end product, i.e., humic-mineral concentrate. Said processes are conducted in a zone confined between the cylindrical anode and the cathode under constant electric and hydrodynamic conditions of said processes, where the direction of electrolyte running is opposite to the sense of anode rotation, with predominant isolation of the humic-mineral concentrate on the anode and its minimized dissolution in the alkaline electrolyte. In addition, both the electrolysis and the electrophoresis processes are carried out under continuous carrying-away of gas bubbles and froth removal and suppression. Exemplary embodiment of the proposed process. The humic-mineral concentrate is produced on specimens of oxidized brown coals of the Borodino and Nazarovo opencast collieries (the Kansk-Achinsk coalfield, the Krasnoyarsk territory), as well as on specimens of brown coals of the Maikuba and Karatau coalfields.

Each of the coal specimens disintegrated down to a particle size of 2 mm is subjected to extraction with a 1-2% aqueous solution under an intense mechanical and vibroacoustical action till formation of a homogeneous carbon-alkaline suspension. The solid-to-liquid phase ratio ranges between 1:2 and 1:8. The resultant suspension comprising humic acid salts (sodium humate), finely divided humic-mineral particles and complexes, unreacted coal particles, and mineral admixtures is allowed to settle for 15, 30, 60, 90, and 120 min. It has been found that a maximum extraction efficiency is attainable when using a 1.5-2% alkali solution with the solid-to-liquid phase ratio of 1:4. A maximum proportion of unreacted coal particles and mineral admixtures are liable to settle down for the initial 60 minutes of the settling procedure.

The starting suspension comprising humic acid salts and finely divided humic-mineral particles and complexes is fed to the zone confined between the anode and cathode. The content of humic acid salts in the suspension ranges from 5 to 9.5 wt. %, that is, from 50 to 95 g per liter with the pH value of the suspension ranging from 8 to 9.5. The content of finely divided humic-mineral particles and complexes in the suspension is from 0.75 to 19 g per liter or from 0.075 to 1.9 wt. %, or from 1.5 to 20% of a total weight of humic acids. The rotational speed of the drum-shaped anode is set within 1.5 to 15 rpm. The operating voltage is 4 to 12 V and current density is from 100 to 500 A/sq.m.

It has been found under intermittent treatment conditions where there is no continuous feeding and withdrawal of the suspension, that the processes of electrolysis of humic acid salts and of electrophoresis of the humic-mineral component of the suspension resulting in isolation of the humic-mineral concentrate on the rotating anode proceeds within the initial 10 to 12 minutes. As soon as the pH value of the suspension exceeds 10.5 the process slows down abruptly due to dynamic equilibrium between the amount of isolated and dissolved humic-mineral concentrate.

It is with the suspension fed and withdrawn continuously under conditions of its countercurrent flow with respect to the rotating anode that a maximum isolation of the humic-mineral concentrate and its removal from the anode surface is attainable.

The following optimum conditions of carrying out the process have been established proceeding from the requirement of providing a maximum efficiency of the process for producing the humic-mineral concentrate, involving a maximum yield of the end product, the value of its pH in the range of from 4.5 to 7, and a minimum content of dry substance in the obtained pastelike and earthlike end product:

voltage 6-8 V

current density 400-500 A/sq.m drum-shaped anode

rotational speed 3-5 rpm. D

With a low anode rotational speed and increased current density an earthlike humic-mineral concentrate is formed, featuring the dry substance content in excess of 18% and the pH value below 5, whereas a higher anode rotational speed and a lower current density result in formation of a pastlike humic-mineral concentrate, featuring the dry substance content of from 13 to 16% and the pH value within 5.5 and 7.

Use of a remover of the suspension film from the surface of the end product increases the dry substance content of the pastlike and earthlike concentrate by 0.4 to 1.2% and reduces the pH value by 0.6 to 0.8.

The process described hereinbefore is carried into effect with the use of the herein-proposed device for producing humic-mineral concentrate.

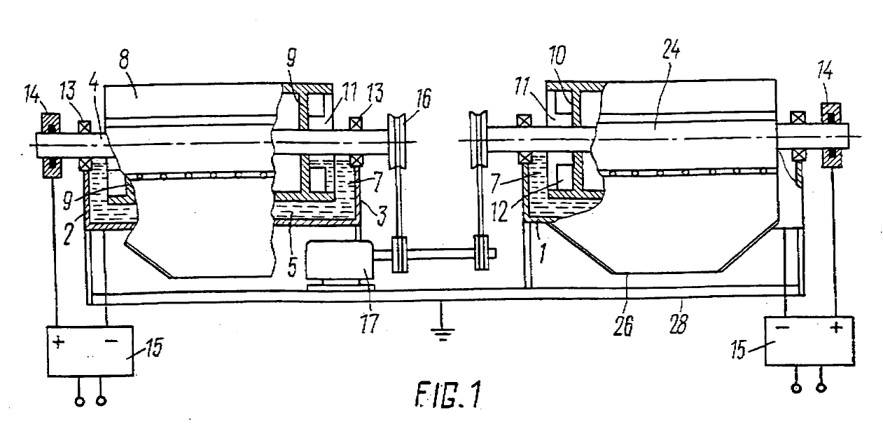

The device for producing humic-mineral concentrate, according to the invention, comprises at least a pair of electrolysis bath 1 (FIG. 1), each of the baths appearing as a cylindrical trough with end walls 2 and 3. A cylindrical drum 8 having end walls 9 and 10 is provided in each bath 1, said drum being set on a shaft 4 coaxially with the bath 1 at a clearance or space. 5 with respect to the bath bottom and at clearances or spaces 6, 7 with respect to the bath end walls 2, 3. The side surface of the drum 8 is coated with a special electrode material, e.g., magnetite. The walls 10 are so installed on the drum end portions facing each other as to establish a damping zone 11 in the space of each anode, said zone accommodating froth-suppressing attachments 12 appearing as, e.g., radially arranged vanes.

Each shaft 4 is supported on bearings 13 which are made from, e.g., a dielectric material and enable the shaft 4 and hence the drum 8 to rotate. Furthermore, each of the shafts 4 carries current supply leads 14 appearing as, e.g., graphite brushes, copper-made shaped hold-down contact bars, and so on and connected to a positive terminal of a current source 15. In addition, each shaft 4 carries a drive attachment 16 appearing as, e.g., a pulley made of a dielectric material and connected to an electric motor drive 17 the number of rpm of which and hence the rotational speed of the drum 8 are adjustable. Each of the pairs of the drums 8 has as a rule its own electric motor drive 17. The current supply lead 14 provides current supply to the drum 8 (thus rendering it the anode) from a source (or sources) which negative terminal is connected to the bath 1, thus rendering it the cathode.

Each pair of the baths 1 Is provided with a common distributing collector appearing as a trough 18 equipped with an intake pipe connector 19 (FIG. 2). The side walls of the trough 18 are provided with overflow holes appearing as slots 20 being, e.g., of a triangular or trapezoidal shape. Each bath 1 is provided with a discharge container appearing as, e.g., a trough 21 communicating with the interior of the bath 1 through overflow holes 22 shaped as, e.g., recesses triangular or trapezoidal in shape, said trough 21 being provided with a discharge pipe connector 23 and having the same length as the drum 8.

Each drum 8 is provided with an end product extractor appearing as, e.g., a scraper 24 adjustable for angle of its contact with the peripheral surface of the drum 8 and for force of pressure exerted by the scraper upon said drum surface. The scraper 24 may be made from a dielectric material; when made from an electrically conducting material the scraper is provided with a dielectric member 25 which establishes electric insulation of the drum 8 from the bath 1. By and large, the bearings 13, the attachment 16, and the member 25 provide for reliable electric insulation of the drum-shaped anode 8 from the bath-shaped cathode. Each scraper has a chamber 26 for collecting and withdrawing the humic-mineral concentrate. The baths 1 are provided with discharge pipe connectors 27 and are mounted on a frame 28.

The number of pairs of the baths 1 may be arbitrary and depends on the desired productivity of the device. FIG. 2 presents an embodiment of the device having two pairs of the baths.

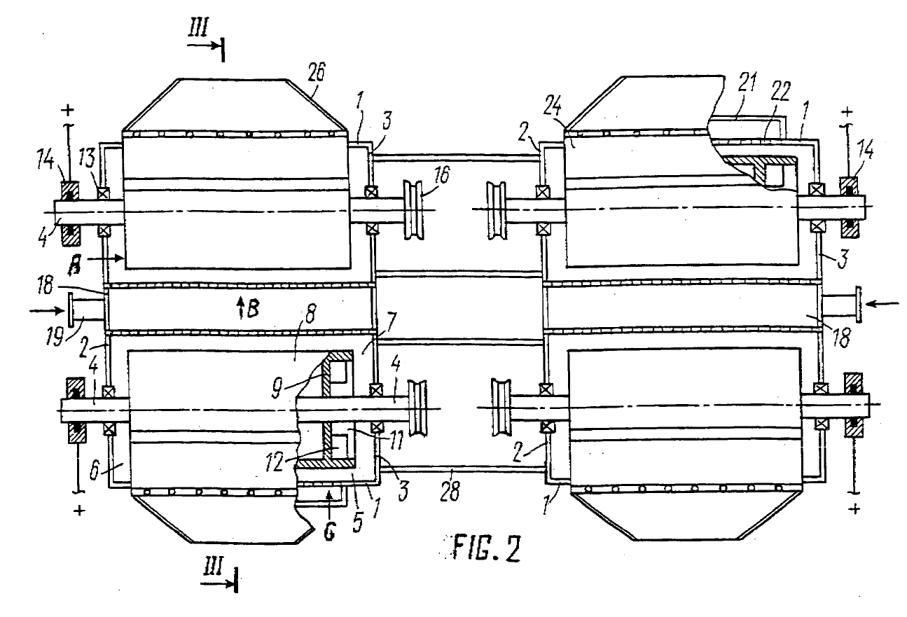

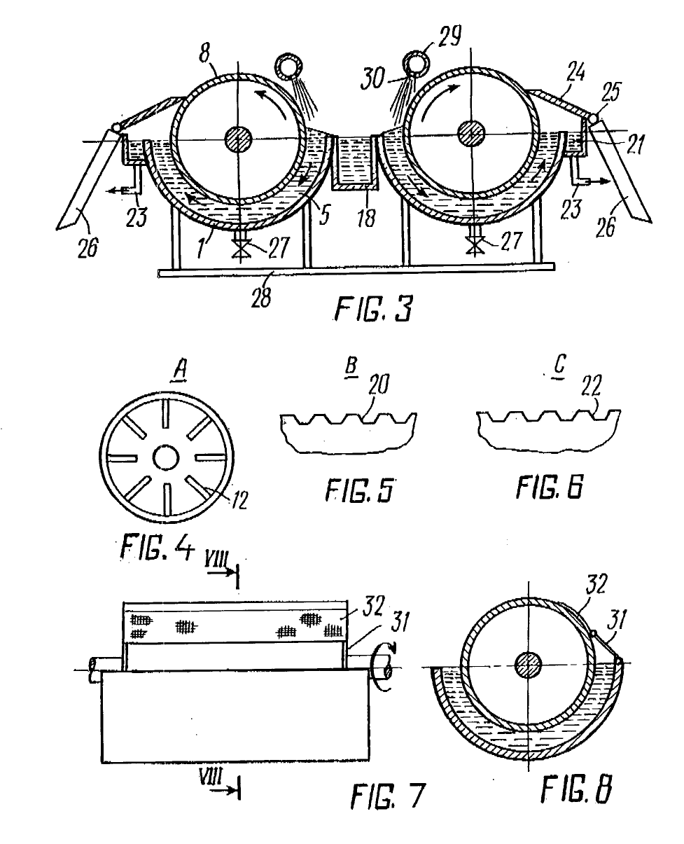

The device may further comprise a remover of the suspension film from the surface of the end product. The remover may appear as a tube 29 (FIG. 3) having a recess 30 and is so arranged that when connected to a source of compressed air the tube 29 feeds a stream of compressed air to the drum 8 in a direction opposite to the sense of the drum rotation. According to another embodiment of said remover presented in FIG. 7, it appears as a frame 31 held to the bath 1 on the side facing the trough 18 and carrying a web of cloth stretched thereover so as to be forced against the surface of the drum 8. Used as the cloth may be any textile, e.g., a linen, or a polyethylene film.

The herein-proposed device operates as follows. The starting aqueous suspension resultant from treating preliminarily disintegrated naturally occurring carbon-series humites and/or caustobiolites with an alkali solution, e.g., that of sodium, potassium, or ammonia water, and comprising dissolved humic acid salts and humic-mineral particles and complexes is fed via the intake pipe connector 19 (FIG. 2) to the trough 18. Once the suspension has filled the trough 18, it passes through the slots 20 to each of the baths 1 to fill them to a definite level. Then each of the drums 8 is set in rotation which is imparted thereto from the electric motor drive 17, via the drive attachment 16 and the shaft 4 so that the drums 8 in each pair rotate oppositely.

A positive potential is applied from the direct current source 15 to each shaft 4 and drum 8 through the current supply lead 14 and a negative potential is supplied to each bath 1. Thus, each drum 8 becomes an anode and each bath becomes a cathode.

The suspension fed through the intake pipe connector 19 to the trough runs therealong to flow through the slots 20 to each of the baths 1. With the drums 8 rotating, the level of the suspension along their side surface increases due to the effect of the viscosity forces. As a result, the upper layer of the suspension located above the slots 20 and the wall of trough 18 gets in the zone of action of the positive potentials of each of the drum-shaped anodes 8. Thus, the charged particles are divided, under the effect of electrostatic forces, that is, the positively charged particles (predominantly sodium or potassium cations depending on whether the former or the latter alkali metal is used for extraction) are displaced away from the zone of action of the positive potential, and the negatively charged particles (predominantly anions of humic acids, as well as humic-mineral particles and complexes) are displaced towards the zone of action of the positive potential. The slots 20 are disposed in the zone of action of the positive potential of each of the nodes. Passing of each elementary volume of the suspension through each slot 20 involves escaping (by the positively charged particles) a definite electrical (potential) barrier, whereas motion of said volume along the trough 18 is not concerned with said escaping. As a result, there occur a definite segregation of the particles, i.e., the negatively charged particles are predominantly accumulated in the clearance or space 5 between the bottom of the bath 1 and the drum 8, whereas the positively charged particles moves along the trough 18. It is due to said fact that the suspension passing through said clearance or space 5 has a lower pH value than the suspension passing along the trough 18 to the clearances or spaces 6, 7 between the end walls of the bath 1 and the drum 8. Further on the higher pH value suspension is discharged from the bath 1.

It is in the clearance or space 5 between the anode (drum 8) and the cathode (bath 1) that there occur the processes of electrolysis of humic acid salts and of electrophoresis of the humic-mineral component of the suspension. Humic acid anions are discharged into the anode to form a layer of material thereon. Besides, part of the humic acid anions is transferred to free humic acids due to acidulation of the near-the-anode zone, which acids also settle down to the anode. Under the action of electrostatic forces the finely divided humic-mineral particles and complexes moves towards the anode and, upon discharging thereinto, settle down as a layer. The humic acids resulting from the electrolysis process and a layer of the finely divided humic-mineral particles resulting from the electrophoresis process make up the end product, viz, humic-mineral concentrate. Next electro-osmotic dehydration of said layer of the end product occurs, with the result that the layer is consolidated, and a great deal of sodium (or potassium) cations is removed therefrom. It is due to a uniform distribution of a flow of the starting suspension over the anode working surface through the slots 20 that identical hydrodynamic and electrochemical conditions are provided for the electrolysis and electrophoresis processes to proceed on the side anode surface.

However, as the suspension flows along the clearance or space 5 between the bath 1 and the drum 8, its composition, the pH value, and the conditions under which the processes proceed are subject to changes.

The humic-mineral concentrate is formed on the adjacent portion of the peripheral surface of the drum-shaped anode 8 from the suspension passing via the slots 20. As the suspension flows from the intake pipe connector 19 to the trough 21 of the discharge container, and as still more humic acid anions and charged finely-divided humic-mineral particles and complexes are discharged from the suspension, the latter gets depleted of humic acid anions and hence its pH value increases. Such an increase in the pH value of the depleted suspension (electrolyte) enhances dissolving action on the humic-mineral concentrate formed on the anode. As a result, there occurs a dynamic equilibrium between the humic-mineral concentrate isolated on the anode and the redissolved concentrate. To shift such an equilibrium towards the formation of the humic-mineral concentrate, the anode rotates in a direction opposite to that of motion of the suspension. Such being the case the anode, while rotating, withdraws continuously the humic-mineral concentrate from the suspension having yet a relatively low pH value (approximating that of the starting suspension), which concentrate is continuously taken off the working surface of the drum-shaped anode 8. Next the humic-mineral concentrate is admitted to pass in the discharge pipe connector 27 and is withdrawn as the end product.

Having passed through the clearance or space 5, the depleted suspension is uniformly discharged from the bath 1 through the overflow holes 22 into the trough 21 whence it fed, via the discharge pipe connector 23, as an alkali reagent for preparing the starting pulp by treating naturally occurring carbon-series humites and caustobiolites.

Apart from the processes of electrolysis and electrophoresis, hydrogen bubbles are isolated on the cathode and oxygen bubbles, on the anode. The presence of such bubbles affects adversely electric conductance of the suspension and intensity of the process for producing humic-mineral concentrate. It is due to a directional flow of the suspension that a continuous carry-away of the bubbles to the zone of bath 1 adjacent to the trough 21 is ensured. The floating up bubbles form froth which is partly destructed when overflowing through the holes 22, while a greater proportion thereof is admitted to pass, via the clearances or spaces 6 and 7 to the end zones of the drum-shaped anode 8. With the drum 8 rotating the vanes 12 destruct (suppress) the froth efficiently. The gases (oxygen and hydrogen) evolving therein are removed by a plenum-exhaust ventilation, for which purpose the device is provided with a casing (not shown).

When taking the humic-mineral concentrate off from the surface of the drum 8, the suspension film is also removed from said surface and is returned to the bath 1 for recycling. The film can be removed by either of the following two ways: (a) by directing a jet of compressed air fed tangentially to the surface of the layer of the humic-mineral concentrate through the recess 30 of the tube 29 (FIG. 3) in a direction opposite to the sense of rotation of the drum 8; and (b) by stripping the film with the aid of the web 32 of cloth stretched over the frame 31 and adapted to be forced against the surface of the drum 8.

1. A process for producing humic-mineral concentrate, comprising the steps of:
selecting a starting liquid-phase alkaline medium of humic acid salts extracted with an alkaline reagent from naturally occurring carbon-series humites and caustobiolites;
using, as said liquid-phase alkaline medium, an aqueous suspension of humic acid salts comprising humic acid salts and finely divided humic-mineral particles and complexes in a proportion of from 1.5 to 20 wt. % of a total weight of humic acid salts;
feeding said aqueous suspension to a bank of baths having rotatable anodes;
distributing uniformly said aqueous suspension when feeding it to said baths, over the surface of said rotatable anodes;
establishing flowing said aqueous suspension in a direction opposite to the sense of rotation of said anodes;
conducting in said bank of baths concurrently proceeding processes of electrolysis of said humic acid salts and of electrophoresis of said finely divided humic-mineral particles and complexes;
isolating humic acids and humic-mineral substances making up said humic-mineral concentrate, on said anodes during said processes of electrolysis and electrophoresis;
establishing damping zone in said anodes for suppressing froth resulting from passing electric current through said aqueous suspension; and
extracting said humic-mineral concentrate.

2. The process of claim 1, wherein use is made of said rotatable anode whose working surface is made of magnetic.

3. The process of claim 1, wherein a suspension film is removed from the surface of the humic-mineral concentrate when extracting the latter.

4. A device for producing humic-mineral concentrate, comprising:
a direct current source;
at least one pair of baths, a first bath and a second bath of said pair, each serving as a cathode and being connected to said direct current source;
at least two anodes connected to said direct current source; a first anode of said two ones situated in said first bath and provided with an end product extractor; a second anode of said two ones disposed in said second bath and provided an end product extractor;
the interior spaces of said two anodes having end zones facing each other;
a distributing collector communicating with said first and second baths via overflow holes for feeding thereto a starting aqueous suspension of humic acid salts;
a discharge container of said first bath positioned under said end product extractor of said first anode;
a discharge container of said second bath positioned under said end product extractor of said second anode;
froth-suppressing attachments of said first and second anodes; and
said first and second anodes mounted rotatably in a direction opposite to the direction of flow of said starting aqueous suspension in said one pair of bath.

5. The device of claim 4, wherein said distributing collector appears as a trough.

6. The device of claim 4, wherein said froth-suppressing attachments appears as vanes arranged in said end zones of the interior spaces of the anodes, said zones facing each other.

7. The device of claim 4, wherein said each overflow hole appears as a slot.

8. The device of claim 4, comprising at least two removers of a suspension film from the end product surface.

9. The device of claim 8, wherein said each remover of a suspension film from the end product surface appears as a slotted tube adapted for feeding a compressed air stream, when connected to a compressed air source, towards the first or second anode in a direction opposite to the sense of rotation of said first or second anode.

10. The device of claim 8, wherein said each remover of a suspension film from the end product surface appears as a frame carrying a web of cloth stretched thereover and adapted to be forced against the surface of said first or second anode.
